(19) United States
(12) Patent Application Publication
(10) Pub. No.: US 2024/0056871 A1
(43) Pub. Date: Feb. 15, 2024

(54) RESOURCE ALLOCATION STATUS SUBSCRIPTION FOR APPLICATION RELATED FUNCTION

(71) Applicant: Telefonaktiebolaget LM Ericsson (publ), Stockholm (SE)

(72) Inventor: Wenliang XU, Shanghai (CN)

(73) Assignee: Telefonaktiebolaget LM Ericsson (publ), Stockholm (SE)

(21) Appl. No.: 18/259,583

(22) PCT Filed: Jan. 14, 2022
(86) PCT No.: PCT/CN2022/071954

§ 371 Date: Jun. 27, 2023

(30) Foreign Application Priority Data
Jan. 15, 2021 (WO) PCTCN2021072057

(51) Int. Cl. H04W 28/02; H04W 28/24

(52) U.S. Cl. CPC H04W 28/0268; H04W 28/24

(57) ABSTRACT

Methods and apparatuses for resolving an issue in resource allocation status subscription for an application related function (ARF). A method of operation of the ARF comprises transmitting a request to an exposure function (EF). Herein, the request comprises a resource allocation confirmation indication that indicates whether a resource allocation status notification is required and a resource allocation status feature that indicates whether the ARF supports a resource allocation status. The resource allocation status notification is used to indicate resource allocation success or resource allocation failure. The method further comprises receiving, from the EF, a response comprising a status response feature that indicates whether both the ARF and the EF support the resource allocation status.

### TECHNICAL FIELD

The present disclosure relates to resolving an interoperability issue between an application related function (ARF) and an exposure function (EF) in a cellular communications system, and, in particular, to resolving an issue in resource allocation status subscription for the ARF.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### External Exposure of Network Capability in 4G

The external exposure of network capability in EPC was driven by MTC (Machine Type Communication). As depicted in FIG. 1, the Service Capability Exposure Function (SCEF) provides a means to securely expose the services and capabilities provided by 3GPP network interfaces. The SCEF provides a means for the discovery of the exposed services and capabilities. The SCEF provides access to network capabilities through homogenous network application programming interfaces (e.g. Network APIs) defined over T8 interface. The SCEF abstracts the services from the underlying 3GPP network interfaces and protocols. T8 is the interface between the SCEF and services capability server or an application server (SCS/AS). SCEF exposed network services can be accessed by SCS/AS through APIs over T8 interface (refer to TS 23.682, cl. 4.2).

The 3rd party SCS/AS may request that a data session to a UE that is served by the 3rd party service provider (AS session) is set up with a specific QoS (e.g. low latency or jitter) and priority handling. This functionality is exposed via the SCEF towards the SCS/AS. As illustrated in FIG. 2, the SCS/AS can request the network to provide QoS for the AS session based on the application and service requirements with the help of a QoS reference parameter which refers to pre-defined QoS information. When the SCEF receives the request from the SCS/AS to provide QoS for an AS session, the SCEF acts as an AF per TS 23.203 [27] specifications and transfers the request to provide QoS for an AS session to the policy and charging rules function (PCRF) via the Rx interface. If the SCEF gets informed about bearer level events for the Rx session (e.g. transmission resources are released/lost) the SCEF shall inform the SCS/AS about it (refer to TS 23.682, cl. 4.5.11 and 5.11).

The SCS/AS may request the SCEF to start or stop sponsoring a data session for a UE that is served by the 3rd party service provider (AS session), i.e. to realize that either the 3rd party service provider is charged for the traffic (start) or not (stop). As illustrated in FIG. 3, the SCS/AS may request to be set as the chargeable party, i.e. sponsoring the traffic, either at AS session set-up or to change it during an ongoing AS session. The SCEF acts as an AF and existing functionality defined in TS 23.203 [27] for sponsored data connectivity is used to support this functionality. If the SCEF gets informed that the Rx session terminates (e.g. due to a release of PDN connection) the SCEF shall inform the SCS/AS about it and shall forward any accumulated usage report received from the PCRF (refer to TS 23.682, cl. 4.5.12 and 5.12).

### External Exposure of Network Capability in 5G

The Network Exposure Function (NEF) supports external exposure of capabilities of network functions, as depicted in FIG. 4. External exposure can be categorized as Monitoring capability, Provisioning capability, Policy/Charging capability and Analytics reporting capability. The Monitoring capability is for monitoring of specific events for UE in 5G System and making such monitoring events information available for external exposure via the NEF. The Provisioning capability is for allowing external party to provision of information which can be used for the UE in 5G System. The Policy/Charging capability is for handling QoS and charging policy for the UE based on the request from external party. The Analytics reporting capability is for allowing an external party to fetch or subscribe/unsubscribe to analytics information generated by 5G System. Policy/Charging capability is comprised of means that allow the request for session and charging policy, enforce QoS policy, and apply accounting functionality. It can be used for specific QoS/priority handling for the session of the UE, and for setting applicable charging party or charging rate. The N33 reference point provides equivalent APIs as T8 interface towards the AF (refer to TS 23.501, cl.5.20).

The AF requested QoS in 5G is supported by NEF N33 API in TS 29.522 (cl.4.4.9), which is re-using the SCEF T8 API in TS 29.122 (cl.4.4.13). FIGS. 5 and 6 are the information flow for the setting up AF session with required QoS procedure in TS 23.502, cl.4.15.6.6 and updating the AF session with required QoS procedure in TS 23.502, cl.4.15.6.6a.

The set of a chargeable party is supported by NEF N33 API in TS 29.522 (cl.4.4.8), which is re-using the SCEF T8 API in TS 29.122 (cl.4.4.4). FIGS. 7 and 8 are the information flow for the setting of chargeable party procedure at AF session set-up and during the AF session update in TS 23.502, cl.4.15.6.4 and 4.15.6.5, correspondingly.

### Problems with Existing Solutions

In existing art (3GPP TS 29.122 release 16), an exposure function (such as a NEF or a SCEF) may send an event notification of a resource allocation status (resource allocation success or resource allocation failure) to an application related function (such as an AF or SCS/AS). However, such event is not specified in the pre-release 16 version. Therefore, when an application related function (from release 16 version onwards) communicates with a exposure function (in the pre-release 16 version), if the application related function (from release 16 version onwards) expects to receive the event notification of the resource allocation status, but there is no support of such event in the exposure function (in the pre-release 16 version), the application related function (from release 16 version onwards) will wait infinitely.

In addition, even if the exposure function supports the resource allocation status event (resource allocation success or resource allocation failure), the exposure function may not further send the event notifications to the application related function. Therefore, the application related function will wait for the successful or failed resource allocation result forever.

### SUMMARY

Certain aspects of the present disclosure and their embodiments may provide solutions to the aforementioned or other challenges. Methods and apparatuses are disclosed herein, in which a resource allocation confirmation indication and a resource allocation status feature are used for resolving an issue in resource allocation status subscription for an application related function.

There are, proposed herein, various embodiments which address one or more of the issues disclosed herein. In one embodiment, a method of operation of an application related function (ARF) comprises transmitting a request to an exposure function (EF). Herein, the request comprises a resource allocation confirmation indication that indicates whether a resource allocation status notification is required. The resource allocation status notification indicates resource allocation success or resource allocation failure.

In one embodiment, the request further comprises a resource allocation status feature that indicates whether the ARF supports a resource allocation status.

In one embodiment, the method of operation of the ARF further comprises receiving, from the EF, a response comprising a status response feature. Herein, the status response feature indicates whether both the ARF and the EF support the resource allocation status.

In one embodiment, when the resource allocation confirmation indication indicates that the resource allocation status notification is required by the ARF and the status response feature indicates that both the ARF and the EF support the resource allocation status, the response further comprises a resource allocation status notification.

In one embodiment, when the resource allocation confirmation indication indicates that the resource allocation status notification is not required by the ARF and/or the status response feature indicates that at least one of the ARF and the EF does not support the resource allocation status, the method further comprises refraining from waiting for a resource allocation status notification from the EF.

In one embodiment, when the resource allocation confirmation indication indicates that the resource allocation status notification is not required by the ARF, the method further comprises refraining from waiting for a resource allocation status notification from the EF.

In one embodiment, when the status response feature indicates that at least one of the ARF and the EF does not support the resource allocation status, the method further comprises refraining from waiting for a resource allocation status notification from the EF.

In one embodiment, the request is a request to set up an AS or AF session with required QoS, a request to update the AS or AF session with required QoS, a request to set a chargeable party at an AS or AF session set-up, or a request to change the chargeable party during the AS or AF session; and the response is a response to set up an AS or AF session with required QoS, a response to update the AS or AF session with required QoS, a response to set a chargeable party at an AS or AF session set-up, or a response to change the chargeable party during the AS or AF session, respectively.

In one embodiment, a bitmask is used for the resource allocation confirmation indication to indicate whether a resource allocation status notification is required, a bitmask is used for the resource allocation status feature to indicate whether the ARF supports the resource allocation status, and a bitmask is used for the status response feature to indicate whether both the ARF and the EF support the resource allocation status.

In one embodiment, the ARF is in a Fifth Generation system. The ARF is an application function (AF), and the EF is a network exposure function (NEF).

In one embodiment, the request is a request to set up an AF session with required QoS, a request to update the AF session with required QoS, a request to set a chargeable party at an AF session set-up, or a request to change the chargeable party during the AF session; and the response is a response to set up an AF session with required QoS, a response to update the AF session with required QoS, a response to set a chargeable party at an AF session set-up, or a response to change the chargeable party during the AF session, respectively.

In one embodiment, the ARF is in a Fourth Generation system. The ARF is a services capability server or an application server (SCS/AS) and the EF is a service capability exposure function (SCEF).

In one embodiment, the request is a request to set up an AS session with required QoS, a request to update the AS session with required QoS, a request to set a chargeable party at an AS session set-up, or a request to change the chargeable party during the AS session; and the response is a response to set up an AS session with required QoS, a response to update the AS session with required QoS, a response to set a chargeable party at an AS session set-up, or a response to change the chargeable party during the AS session, respectively.

Corresponding embodiments of an ARF are also disclosed. In one embodiment, the ARF is adapted to transmit a request to an EF and receive a response from the EF. Herein, the request comprises a resource allocation confirmation indication that indicates whether a resource allocation status notification is required and a resource allocation status feature that indicates whether the ARF supports a resource allocation status. The resource allocation status notification indicates resource allocation success or resource allocation failure. The response comprises a status response feature that indicates whether both the ARF and the EF support the resource allocation status.

In one embodiment, a network node that implements an ARF comprises a network interface and processing circuitry associated with the network interface. The processing circuitry is configured to cause the network node to transmit a request to an EF and receive a response from the EF. Herein, the request comprises a resource allocation confirmation indication that indicates whether a resource allocation status notification is required and a resource allocation status feature that indicates whether the ARF supports a resource allocation status. The response comprises a status response feature that indicates whether both the ARF and the EF support the resource allocation status.

In one embodiment, a method of operation of an EF comprises receiving from a request an ARF. Herein, the request comprises a resource allocation confirmation indication that indicates whether a resource allocation status notification is required. The resource allocation status notification indicates resource allocation success or resource allocation failure.

In one embodiment, the request further comprises a resource allocation status feature that indicates whether the ARF supports a resource allocation status.

In one embodiment, the method of operation of the EF further comprises transmitting, from the EF, a response comprising a status response feature. Herein, the status response feature indicates whether both the ARF and the EF support the resource allocation status.

In one embodiment, when the resource allocation confirmation indication indicates that the resource allocation status notification is required by the ARF and the status response feature indicates that both the ARF and the EF support the resource allocation status, the response further comprises a resource allocation status notification.

In one embodiment, when the resource allocation confirmation indication indicates that the resource allocation status notification is not required by the ARF and/or the status response feature indicates that at least one of the ARF and the EF does not support the resource allocation status, the method further comprises refraining from waiting for a resource allocation status notification from the EF.

In one embodiment, when the resource allocation confirmation indication indicates that the resource allocation status notification is not required by the ARF, the method further comprises refraining from waiting for a resource allocation status notification from the EF.

In one embodiment, when the status response feature indicates that at least one of the ARF and the EF does not support the resource allocation status, the method further comprises refraining from waiting for a resource allocation status notification from the EF.

In one embodiment, the request is a request to set up an AS or AF session with required QoS, a request to update the AS or AF session with required QoS, a request to set a chargeable party at an AS or AF session set-up, or a request to change the chargeable party during the AS or AF session; and the response is a response to set up an AS or AF session with required QoS, a response to update the AS or AF session with required QoS, a response to set a chargeable party at an AS or AF session set-up, or a response to change the chargeable party during the AS or AF session, respectively.

In one embodiment, a bitmask is used for the resource allocation confirmation indication to indicate whether a resource allocation status notification is required, a bitmask is used for the resource allocation status feature to indicate whether the ARF supports the resource allocation status, and a bitmask is used for the status response feature to indicate whether both the ARF and the EF support the resource allocation status.

In one embodiment, the ARF is in a Fifth Generation system. The ARF is an AF, and the EF is a NEF.

In one embodiment, the request is a request to set up an AF session with required QoS, a request to update the AF session with required QoS, a request to set a chargeable party at an AF session set-up, or a request to change the chargeable party during the AF session; and the response is a response to set up an AF session with required QoS, a response to update the AF session with required QoS, a response to set a chargeable party at an AF session set-up, or a response to change the chargeable party during the AF session, respectively.

In one embodiment, the ARF is in a Fourth Generation system. The ARF is an SCS/AS and the EF is an SCEF.

In one embodiment, the request is a request to set up an AS session with required QoS, a request to update the AS session with required QoS, a request to set a chargeable party at an AS session set-up, or a request to change the chargeable party during the AS session; and the response is a response to set up an AS session with required QoS, a response to update the AS session with required QoS, a response to set a chargeable party at an AS session set-up, or a response to change the chargeable party during the AS session, respectively.

In one embodiment, the method of operation of the EF further comprises determining whether the resource allocation status is supported by the EF, after receiving the request.

In one embodiment, the method of operation of the EF further comprises authorizing the request from the ARF.

In one embodiment, the method of operation of the EF further comprises interacting with a policy function (PF), when the authorization is granted.

In one embodiment, the PF is a policy and charging rules function (PCRF) or a policy control function (PCF).

In one embodiment, when the resource allocation status is not supported by at least one of the ARF and EF, the EF subscribes to the PF to get the resource allocation status notification, but does not transmit the resource allocation status notification to the ARF.

In one embodiment, when both the ARF and the EF support the resource allocation status, the EF subscribes to the PF to get the resource allocation status notification only if the resource allocation status notification is required by the ARF.

Corresponding embodiments of an EF are also disclosed. In one embodiment, the EF is adapted to receive a request from an ARF and transmit a response to the ARF. Herein, the request comprises a resource allocation confirmation indication that indicates whether a resource allocation status notification is required and a resource allocation status feature that indicates whether the ARF supports a resource allocation status. The resource allocation status notification indicates resource allocation success or resource allocation failure. The response comprises a status response feature that indicates whether both the ARF and the EF support the resource allocation status.

In one embodiment, a network node that implements an EF comprises a network interface and processing circuitry associated with the network interface. The processing circuitry is configured to cause the network node to receive a request from an ARF and transmit a response to the ARF. Herein, the request comprises a resource allocation confirmation indication that indicates whether a resource allocation status notification is required and a resource allocation status feature that indicates whether the ARF supports a resource allocation status. The response comprises a status response feature that indicates whether both the ARF and the EF support the resource allocation status.

Certain embodiments may provide one or more of the following technical advantage(s). For example, certain embodiments solve the interoperability issue between the ARF and the EF. The ARF will not wait infinitely, even if the ARF expects to receive a resource allocation status notification, which indicates resource allocation failure or resource allocation success, from the EF that does not support to transmit such notification.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an architecture for service capability exposure function in a 4G network.

FIG. 2 illustrates a procedure for setting up an AS session with required QoS.

FIG. 3 illustrates a procedure for setting or changing the chargeable party at AS session set-up or during the AS session, respectively.

FIG. 4 illustrates an architecture for network exposure function in a 5G network.

FIG. 5 illustrates a procedure for setting up an AF session with required QoS.

FIG. 6 illustrates a procedure for updating an AF session with required QoS.

FIG. 7 illustrates a procedure for setting the chargeable party at AF session set-up.

FIG. 8 illustrates a procedure for changing the chargeable party during the AS session.

FIG. 9 illustrates one example of a cellular communications system according to some embodiments of the present disclosure.

FIG. 10 illustrates one example of an architecture for service capability exposure function in a 4G network.

FIG. 11 illustrates one example of an architecture for network exposure function in a 5G network.

FIGS. 12A-12C illustrate operations within the architectures shown in the FIG. 10 or 11 according to some the embodiments of the present disclosure.

FIG. 13 is a schematic block diagram of a network node according to some embodiments of the present disclosure.

FIG. 14 is a schematic block diagram that illustrates a virtualized embodiment of the network node of FIG. 13 according to some embodiments of the present disclosure.

FIG. 15 is a schematic block diagram of the network node of FIG. 13 according to some other embodiments of the present disclosure.

FIG. 16 illustrates a telecommunication network connected via an intermediate network to a host computer in accordance with some embodiments of the present disclosure.

FIG. 17 is a generalized block diagram of a host computer communicating via a base station with a UE over a partially wireless connection in accordance with some embodiments of the present disclosure.

FIG. 18 is a flowchart illustrating a method implemented in a communication system in accordance with one embodiment of the present disclosure.

FIG. 19 is a flowchart illustrating a method implemented in a communication system in accordance with one embodiment of the present disclosure.

FIG. 20 is a flowchart illustrating a method implemented in a communication system in accordance with one embodiment of the present disclosure.

FIG. 21 is a flowchart illustrating a method implemented in a communication system in accordance with one embodiment of the present disclosure.

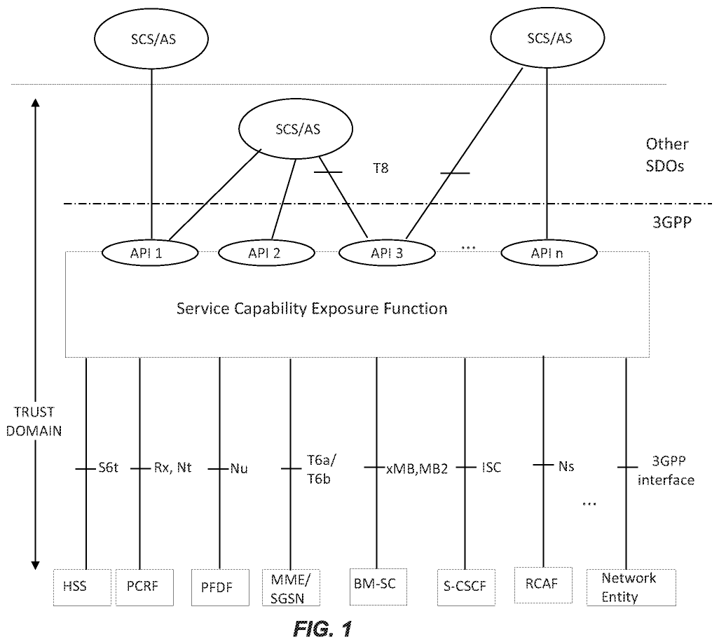

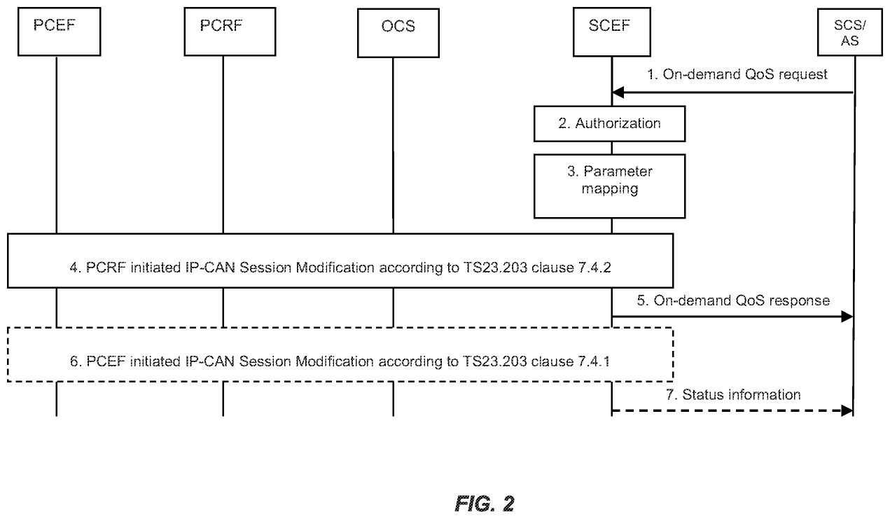

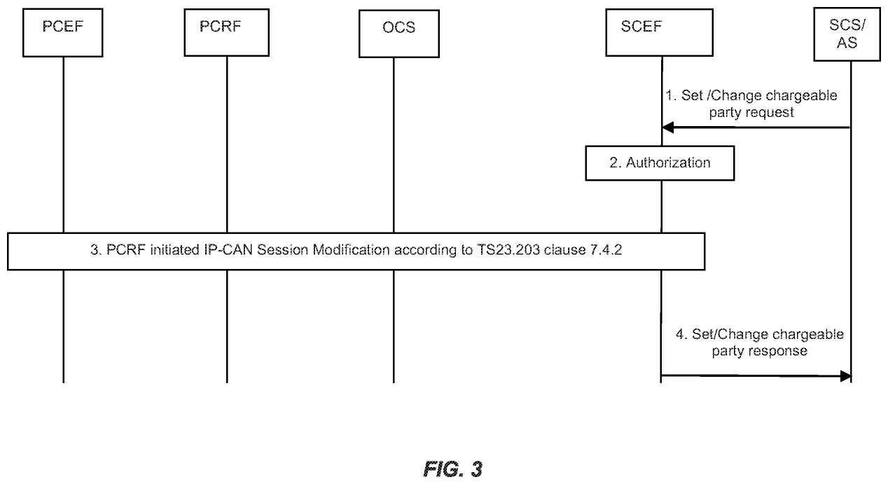

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

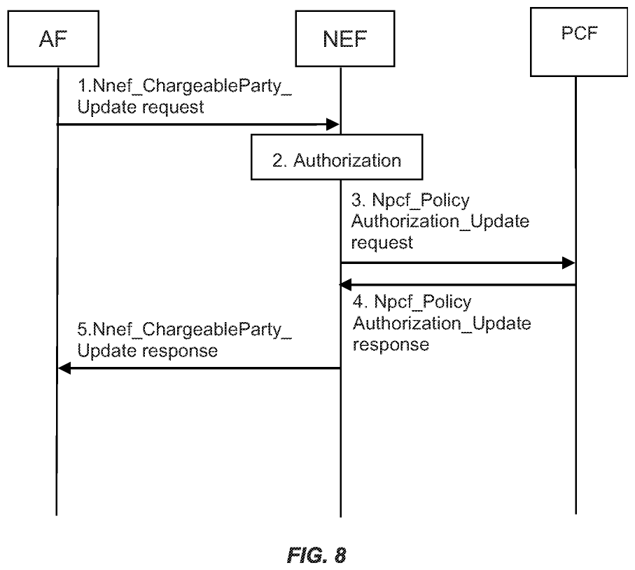

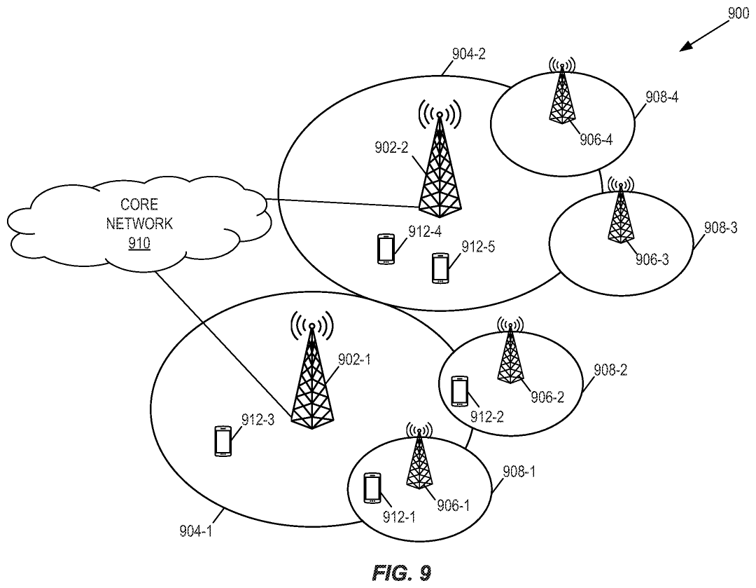

FIG. 9 illustrates one example of a cellular communications system 900 in which embodiments of the present disclosure may be implemented. In the embodiments described herein, the cellular communications system 900 is a 5G system (5GS) including a Next Generation RAN (NG-RAN) and a 5G Core (5GC) or a 4G system (4GS), such as LTE. In this example, the RAN includes base stations 902-1 and 902-2, which in the 5GS include NR base stations (gNBs) and optionally next generation eNBs (ng-eNBs) (e.g., LTE RAN nodes connected to the 5GC) and in the 4GS include eNBs, controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or Remote Radio Heads (RRHs), or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5G System (5GS) is referred to as the 5GC. The base stations 902 (and optionally the low power nodes 906) are connected to the core network 910.

The base stations 902 and the low power nodes 906 provide service to wireless communication devices 912-1 through 912-5 in the corresponding cells 904 and 908. The wireless communication devices 912-1 through 912-5 are generally referred to herein collectively as wireless communication devices 912 and individually as wireless communication device 912. In the following description, the wireless communication devices 912 are oftentimes UEs, but the present disclosure is not limited thereto.

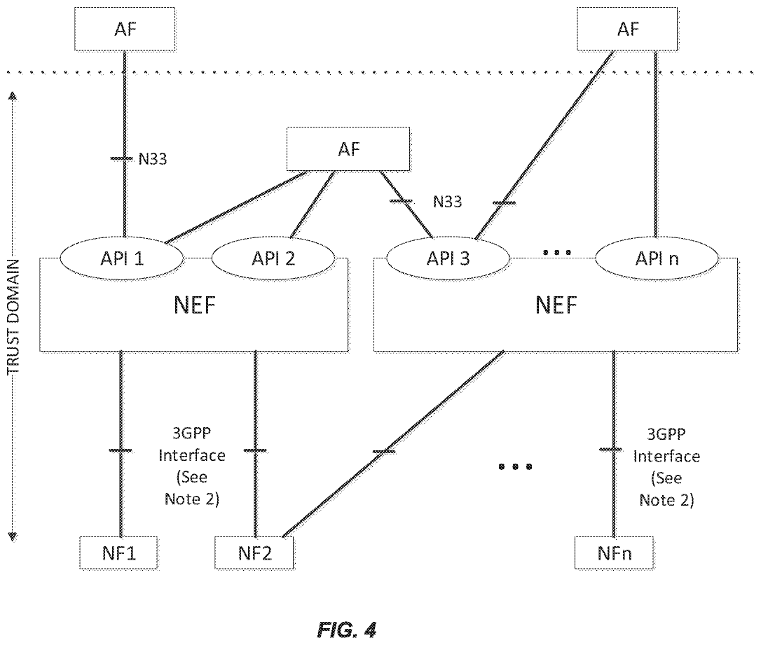

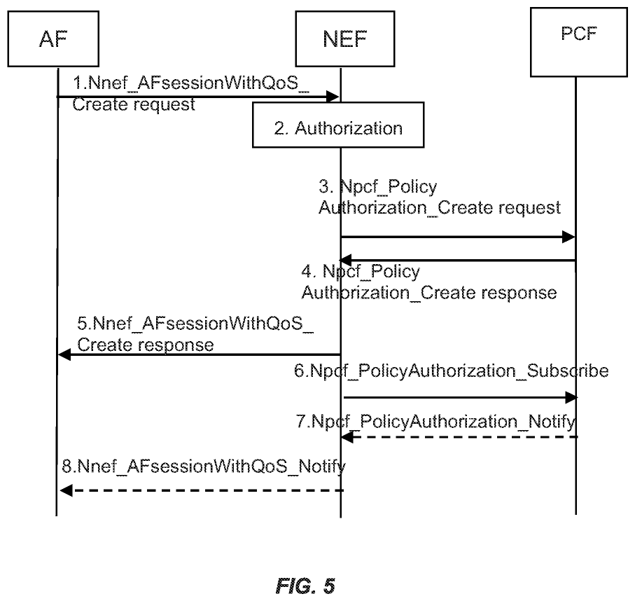

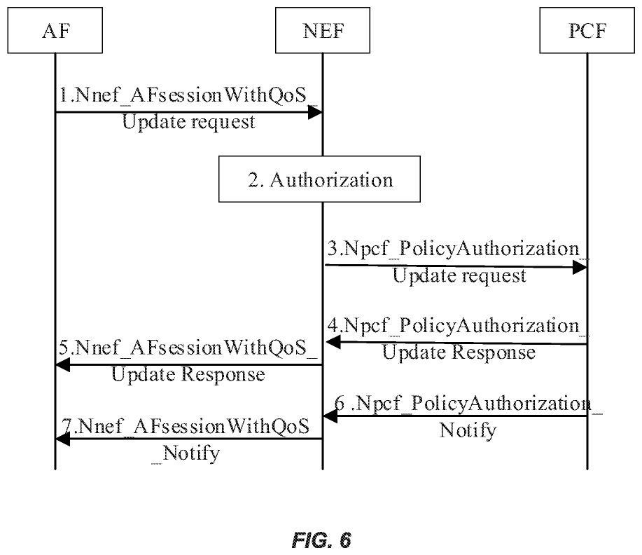

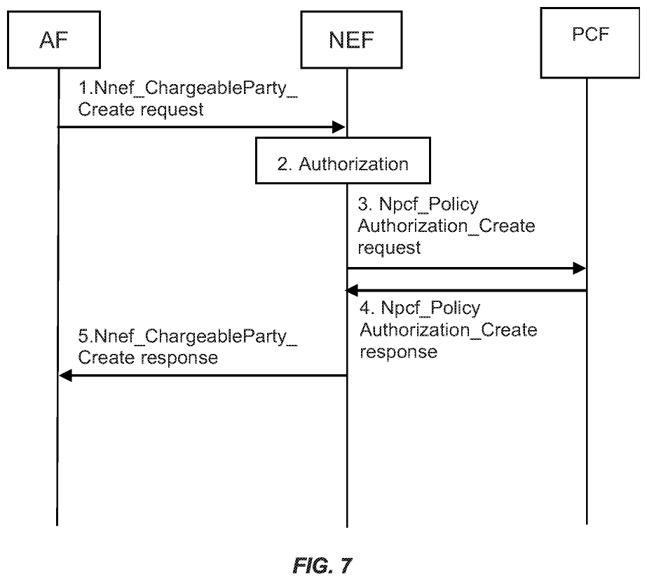

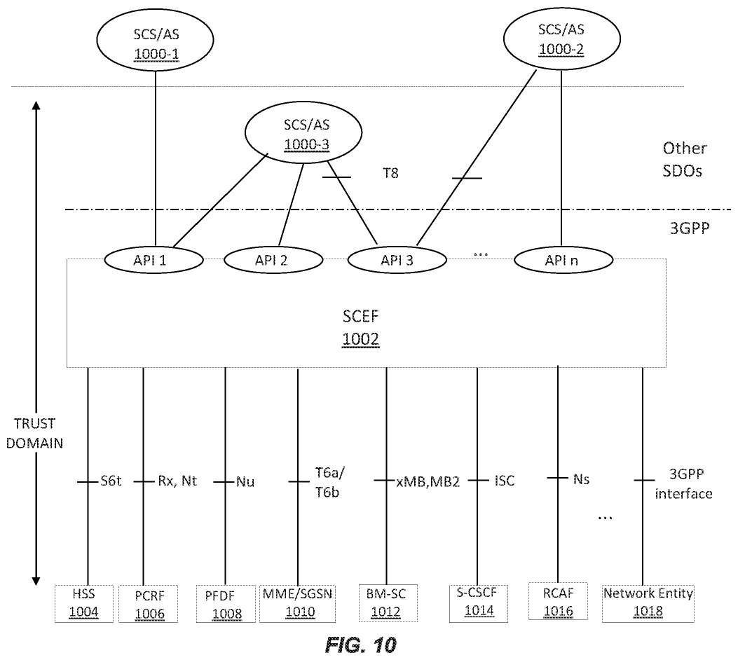

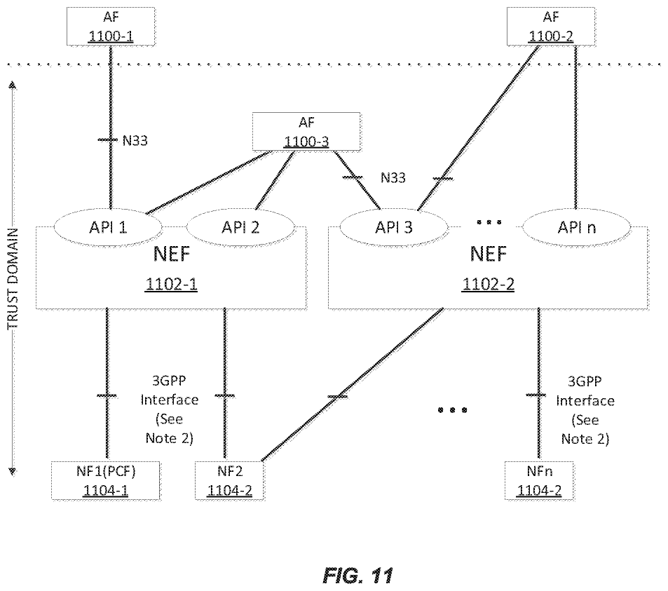

FIGS. 10 and 11 show some system architectures of the cellular communications system 900, in which the embodiments of the present disclosure can be implemented. FIG. 10 schematically shows a 3GPP architecture for service capability exposure in a 4G network which is same as FIGS. 4.2-2 of 3GPP TS 23.682 V16.6.0, the disclosure of which is incorporated by reference herein in its entirety. The system architecture of FIG. 10 may comprise some exemplary elements such as services capability server/application server (SCS/AS) 1000, service capability exposure function (SCEF) 1002, home subscriber server (HSS) 1004, policy and charging rules function (PCRF) 1006, packet flow description function (PFDF) 1008, Mobile Management Entity/Serving GPRS (General Packet Radio Service) Support Node (MME/SGSN) 1010, Broadcast Multicast-Service Centre (BM-SC) 1012, Serving-Call Session Control Function (S-CSCF) 1014, RAN Congestion Awareness Function (RCAF) 1016, and network entity 1018. The network elements and interfaces as shown in FIG. 10 may be same as the corresponding network elements and interfaces as described in 3GPP TS 23.682 V16.6.0.

FIG. 11 schematically shows a non-roaming architecture for Network Exposure Function reference point representation (5G core network), which is same as FIG. 4.2.3-5 of 3GPP TS 23.501 V16.4.0, the disclosure of which is incorporated by reference herein in its entirety. The system architecture of FIG. 11 may comprise some exemplary elements such as Application Function (AF) 1100, Network Exposure Function (NEF) 1102, and network function (NF) 1104. In one embodiment, the NF 1104 may be policy control function (PCF) 1104, and N30 interface is between the NEF 1102 and the PCF 1104. The network elements, reference points and interfaces as shown in FIG. 11 may be same as the corresponding network elements, reference points and interfaces as described in 3GPP TS 23.501 V16.4.0.

The exposure function entity such as the SCEF 1002 in FIG. 10 or the NEF 1102 in FIG. 11 may provide a means to securely expose the services and capabilities provided by the network (such as 3GPP network) interfaces. The exposure function entity may provide a means for the discovery of the exposed services and capabilities. The exposure function entity may provide access to network capabilities through network application programming interfaces (e.g. Network APIs). The exposure function entity may abstract the services from the underlying network interfaces and protocols.

There may be various kinds of network exposure services. For example, monitoring capability may be used for monitoring of specific event for a terminal device in a network such as 4G/5G system and making such monitoring events information available for external exposure via the exposure function entity such as the SCEF 1002 or the NEF 1102. The provisioning capability may be used for allowing external party to provision of information which can be used for the terminal device such as UE in the network such as 4G/5G system. The policy/charging capability may be used for handling QoS (quality of service) and charging policy for the terminal device such as UE based on the request from an external party. The analytics reporting capability may be used for allowing an external party to fetch or subscribe/unsubscribe to analytics information generated by the network such as 4G/5G system. Data capability may be used for allowing an external party to communicate with a terminal device such as UE via an application programming interface.

In one embodiment, the exposure function entity may support network exposure function and network exposure services as described in 3GPP TS 23.501 V16.4.0. In another embodiment, the exposure function entity may support the network exposure function as described in 3GPP TS 23.682 V16.6.0.

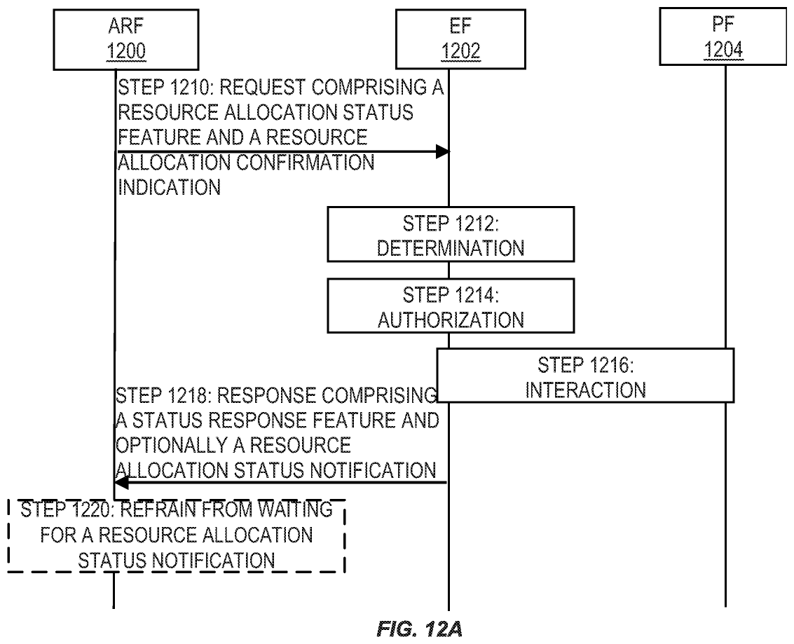

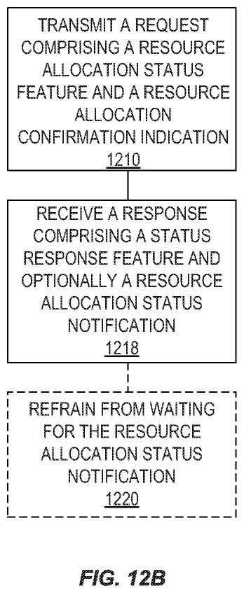

FIG. 12A illustrated operations within the architectures shown in the FIG. 10 or 11 according to some the embodiments of the present disclosure. As illustrated, an application related function (ARF) 1200, transmits, and an exposure function (EF) 1202, receives, a request (step 1210). Herein, the ARF 1200 might be the SCS/AS 1000 as shown in a 4G system in FIG. 10, or the AF 1100 as shown in 5G system in FIG. 11. The EF 1202 might be the SCEF 1002 as shown in 4G system in FIG. 10, or the NEF 1102 as shown in 5G system in FIG. 11.

The request, from the ARF 1200 to EF 1202, may be a different request for different network systems and/or for different procedures. For instance, in a 4G system as shown in FIG. 10, the request may be a request to set up an AS session with required QoS (utilizing an On-demand QoS request message as described in 3GPP TS 23.682 V16.6.0), a request to update the AS session with required QoS, a request to set a chargeable party at an AS session set-up (a set chargeable party request message as described in 3GPP TS 23.682 V16.6.0), or a request to change the chargeable party during the AS session (a change chargeable party request message as described in 3GPP TS 23.682 V16.6.0). For another instance, in a 5G system as shown in FIG. 11, the request may be a request to set up an AF session with required QoS (utilizing a Nnef_AFsessionWithQoS_Create request message as described in 3GPP TS 23.502 V16.5.0), a request to update the AF session with required QoS (a Nnef_AFsessionWithQoS_Update request message as described in 3GPP TS 23.502 V16.5.0), a request to set a chargeable party at an AF session set-up (a Nnef_ChargeableParty_Create request message as described in 3GPP TS 23.502 V16.5.0), or a request to change the chargeable party during the AF session (a Nnef_ChargeableParty_Update request message as described in 3GPP TS 23.502 V16.5.0).

The request, from the ARF 1200 to EF 1202, includes a resource allocation status feature and a resource allocation confirmation indication. Herein, the resource allocation status feature indicates that whether the ARF 1200 supports a resource allocation status, and the resource allocation confirmation indication indicates whether a resource allocation status notification is required by the ARF 1200 in accordance with the resource allocation status feature. If the ARF 1200 requires the resource allocation status notification, the ARF 1200 will wait for the resource allocation status notification from the EF 1202. If the ARF 1200 does not require the resource allocation status notification, the ARF 1200 will not wait for the resource allocation status notification from the EF 1202.

In one embodiment, a bitmask may be used for the resource allocation status feature to indicate whether the ARF 1200 supports a resource allocation status. The resource allocation status feature may utilize value set “0 and 1” or “true and false”. When the value of the resource allocation status feature is “1” or “true”, the resource allocation status feature indicates that the ARF 1200 supports a resource allocation status (the ARF 1200 is capable to receive (from the EF 1202) a resource allocation status notification that indicates resource allocation failure or resource allocation success). When the value of the resource allocation status feature is “0” or “false”, the resource allocation status feature indicates that the ARF 1200 does not supports the resource allocation status.

Similarly, a bitmask may be used for the resource allocation confirmation indication to indicate whether the resource allocation status notification is required by the ARF 1200. The resource allocation confirmation indication may utilize value set “0 and 1” or “true and false”. When the value of the resource allocation confirmation indication is “1” or “true”, the resource allocation confirmation indication indicates that the resource allocation status notification is required by the ARF 1200. When the value of the resource allocation confirmation indication is “0” or “false”, the resource allocation confirmation indication indicates that the resource allocation status notification is not required by the ARF 1200.

After receiving the request, the EF 1202 determines (step 1212) whether the resource allocation status is supported by the EF 1202 (whether the EF 1202 is capable to transmit (to the ARF 1200) a resource allocation status notification that indicates the resource allocation failure or the resource allocation success). Only if the resource allocation status is supported by both the ARF 1200 and the EF 1202, the ARF 1200 may receive the resource allocation status notification.

At the EF 1202, the EF 1202 also authorizes (step 1214) the request from the ARF 1200. The authorization is performed based on which request is implemented. Once the authorization is granted, the EF 1202 will interacts (step 1216) with a policy function (PF) 1204. Herein, the PF 1204 might be the PCRF 1006 as shown in 4G system in FIG. 10, or the PCF 1104 as shown in 5G system in FIG. 11. The EF 1202 provides at least some information included in the request (from the ARF 1200) to the PF 1204, and the PF 1204 determines whether the request is allowed and notifies the EF 1202 if the request is not authorized. Furthermore, during the interaction with the PF 1204, the EF 1202 may also request to be notified by the PF 1204 about the resource allocation status.

In one embodiment, when the resource allocation status is supported by both the ARF 1200 and the EF 1202, the EF 1202 subscribes to the PF 1204 get the resource allocation status notification only if the resource allocation status notification is required by the ARF 1200 (the value of the resource allocation confirmation indication is “1” or “true). Herein the resource allocation status notification indicates resource allocation failure or resource allocation success, such as INDICATION_OF_SUCCESSFUL_RESOURCES_ALLOCATION and INDICATION_OF_FAILED_RESOURCES_ALLOCATION events.

In one embodiment, when the resource allocation status is not supported by at least one of the ARF 900 and EF 1202, the EF 1202 may still subscribes to the PF 1204 get the resource allocation status notification, but does not pass the resource allocation status notification to the ARF 1200. Herein, the EF 1202 may perform certain local statistics based on the subscribed events.

The EF 1202 then transmits, and the AF 120 receives, a response (step 1218). Herein, the response, from the EF 1202 to the ARF 1200, may be a different response in accordance with the implemented request. For instance, in a 4G system as shown in FIG. 10, the response may be a response to set up an AS session with required QoS (utilizing an On-demand QoS response message as described in 3GPP TS 23.682 V16.6.0), a response to update the AS session with required QoS, a response to set a chargeable party at an AS session set-up (a set chargeable party response message as described in 3GPP TS 23.682 V16.6.0), or a response to change the chargeable party during the AS session (a change chargeable party response message as described in 3GPP TS 23.682 V16.6.0). For another instance, in a 5G system as shown in FIG. 11, the response may be a response to set up an AF session with required QoS (utilizing a Nnef_AFsessionWithQoS_Create response message as described in 3GPP TS 23.502 V16.5.0), a response to update the AF session with required QoS (a Nnef_AFsessionWithQoS_Update response message as described in 3GPP TS 23.502 V16.5.0), a response to set a chargeable party at an AF session set-up (a Nnef_ChargeableParty_Create response message as described in 3GPP TS 23.502 V16.5.0), or a response to change the chargeable party during the AF session (a Nnef_ChargeableParty_Update response message as described in 3GPP TS 23.502 V16.5.0).

The response includes a status response feature that indicates whether both the ARF 1200 and the EF 1202 support the resource allocation status. In one embodiment, a bitmask is used for the status response feature to indicate whether both the ARF 1200 and the EF 1202 support the resource allocation status. The status response feature may utilize value set “0 and 1” or “true and false”. When the value of the status response feature is “1” or “true”, the status response feature indicates that both the ARF 1200 and the EF 1202 support the resource allocation status. When the value of the status response feature is “0” or “false”, the status response feature indicates that at least one of the ARF 1200 and the EF 1202 does not support the resource allocation status.

By receiving the status response feature with the value of “1” or “true”, the ARF 1200 is notified that both the ARF 1200 and the EF 1202 support the resource allocation status. In consequence, if the value of the resource allocation confirmation indication is “1” or “true” (the resource allocation status notification is required by the ARF 1200), the response, from the EF 1202 to the ARF 1200, will further include a resource allocation status notification that indicates resource allocation failure or resource allocation success, such as INDICATION_OF_SUCCESSFUL_RESOURCES_ALLOCATION and INDICATION_OF_FAILED_RESOURCES_ALLOCATION events. However, if the value of the resource allocation confirmation indication is “0” or “false” (the resource allocation status notification is not required by the ARF 1200), the EF 1202 is capable to but will not transmit the resource allocation status notification to the ARF 1200. The ARF 1200 refrains from waiting for the resource allocation status notification (step 1220).

By receiving the status response feature with the value of “0” or “false”, the ARF 1200 is notified that at least one of the ARF 1200 and the EF 1202 does not support the resource allocation status. Then the ARF 1200 refrains from waiting for the resource allocation status notification (step 1220).

FIG. 12B is a flow chart illustrating the operation of an application related function, like ARF 1200, in accordance with some embodiments. In step 1210, the ARF 1200 transmits, to an exposure function, like the EF 1202, a request that includes a resource allocation status feature and a resource allocation confirmation indication. The resource allocation status feature indicates that whether the ARF 1200 supports a resource allocation status, and the resource allocation confirmation indication indicates whether a resource allocation status notification is required by the ARF 1200 in accordance with the resource allocation status feature. Then, in step 1218, the ARF 1200 receives, from the EF 1202, a response that includes a status response feature that indicates whether both the ARF 1200 and the EF 1202 support the resource allocation status and optionally includes a resource allocation status notification to indicate the resource allocation failure or the resource allocation success. In one embodiment, if the resource allocation confirmation indication indicates the resource allocation status notification is required by the ARF 1200 and the status response feature indicates that both the ARF 1200 and the EF 1202 support resource allocation status, the response will also include a resource allocation status notification to indicate the resource allocation failure or the resource allocation success. In another embodiment, if the status response feature indicates that at least one of the ARF 1200 and the EF 1202 does not support resource allocation status, the response will not include a resource allocation status notification and the ARF 1200 will refrain from waiting for the resource allocation status notification from the EF 1202 in step 1220.

FIG. 12C is a flow chart illustrating the operation of an exposure function, like the EF 1202, in accordance with some embodiments. In step 1210, the EF 1202 receives, from an application related function, like the ARF 1200, a request that includes a resource allocation status feature and a resource allocation confirmation indication. The resource allocation status feature indicates that whether the ARF 1200 supports a resource allocation status, and the resource allocation confirmation indication indicates whether a resource allocation status notification is required by the ARF 1200 in accordance with the resource allocation status feature. Then, in step 1212, the EF 1202 determines whether the resource allocation status is supported by the EF 1202. In step 1214, the EF 1202 authorizes the request from the ARF 1200. Herein, the step 1212 may be performed before, after, or at the same time as the step 1214. Once the request is authorized, the EF 1202 interacts with a policy function, like the PF 1204, in step 1216. During the interaction with the PF 1204, the EF 1202 may request to be notified by the PF 1204 about the resource allocation status. At last, in step 1218, the EF 1202 transmits, to the ARF 1200, a response that includes a status response feature that indicates whether both the ARF 1200 and the EF 1202 support the resource allocation status and optionally includes a resource allocation status notification to indicate the resource allocation failure or the resource allocation success. In one embodiment, if the resource allocation confirmation indication indicates the resource allocation status notification is required by the ARF 1200 and the status response feature indicates that both the ARF 1200 and the EF 1202 support resource allocation status, the response will also include a resource allocation status notification to indicate the resource allocation failure or the resource allocation success. In another embodiment, if the status response feature indicates that at least one of the ARF 1200 and the EF 1202 does not support resource allocation status, the response will not include a resource allocation status notification.

One example implementation of at least some aspects of the embodiments described herein are described below as changes to 3GPP TS 29.122 V16.8.0. In particularly, subclauses 4.4.4, 4.4.13, 5.5.2.1.2 (with Table 5.5.2.1.2-1), 5.5.4 (with Table 5.5.4-1), 5.14.2.1.2 (with Table 5.14.2.1.2-1), 5.15.2.2.3 (with Table 5.14.2.2.3-1), 5.14.4 (with Table 5.14.4-1), A.2, A.5, and A.14 are changed. Subclauses 5.2.1.2.5 (with Table 5.2.1.2.5-1), 5.2.1.2.6 (with Table 5.2.1.2.6-1), and 5.2.1.3.3 (with Table 5.2.1.3.3-1) are voided. Subclauses 5.5.2.1.x (with Table 5.5.2.1.x-1), 5.5.2.1.y (with Table 5.5.2.1.y-1), 5.5.2.x, 5.5.2.x.1, 5.5.2.x.2 (with Table 5.5.2.x.2-1), and 5.5.2.x.3 (with Table 5.5.2.x.3-1) are newly added.

### *** 1st Change ****

### 4.4.4 Procedures for Changing the Chargeable Party at Session Set Up or During the Session

This procedure is used by an SCS/AS to either request to sponsor the traffic from the beginning or to request becoming the chargeable party at a later point in time via the T8 interface.

When setting up the connection between the AS and the UE via the SCEF, the SCS/AS shall send an HTTP POST request to the SCEF, targeting the “Chargeable Party Transactions” resource, to become the chargeable party for the session to be set up. The body of the HTTP POST message shall include the SCS/AS Identifier, UE IP address, IP Flow description, Sponsor ID, ASP ID, Sponsoring Status, notification destination URI identifying the recipient of notifications within the “notificationDestination” attribute and may include the time period and/or traffic volume used for sponsoring. The SCS/AS may also request to activate a previously selected policy of background data transfer by including the associated Reference ID in the body of the HTTP POST message.

After receiving the HTTP POST request, if the authorization performed by the SCEF is successful, the SCEF shall act as an AF and interact with the PCRF via the Rx interface, as defined in 3GPP TS 29.214 [10] or 3GPP TS 29.201 [13], to trigger a PCRF initiated IP-CAN Session Modification. The SCEF may map the SCS/AS Identifier to AF Application Identifier and may request to be notified about the traffic plane status. If the time period and/or traffic volume are received from the AF, the SCEF should subscribe with the PCRF to the USAGE REPORT event. If the “ResAllocStatus” feature is supported and the “resConfirmInd” is set to true, the SCEF shall subscribe to the PCRF on the INDICATION_OF_SUCCESSFUL_RESOURCES_ALLOCATION and INDICATION_OF_FAILED_RESOURCES_ALLOCATION events.

After receiving a successful response from the PCRF, the SCEF shall create a new “Individual Chargeable Party Transaction” resource, which represents the chargeable party transaction, addressed by a URI that contains the SCS/AS identity and an SCEF-created transaction identifier, and shall respond to the SCS/AS with a 201 Created status code, including a Location header field containing the URI of the created Procedures for changing the chargeable party at session set up or during the resource. The SCS/AS shall use the URI received in the Location header in subsequent requests to the SCEF to refer to this chargeable party transaction. If the SCEF receives a response with an error code from the PCRF, the SCEF shall not create a resource and respond to the SCS/AS with a corresponding failure code as described in subclause 5.2.6.

In order to update the sponsoring status of an established AS session, the SCS/AS shall send an HTTP PATCH message to the SCEF targeting the associated “Individual Chargeable Party Transaction” resource requesting to change the Sponsoring Status. When receiving the HTTP PATCH message, the SCEF shall make the change and interact with the PCRF to modify the Rx session as defined in 3GPP TS 29.214 [10] or 3GPP TS 29.201 [13]. After receiving a response with successful result code from the PCRF, the SCEF shall send an HTTP response to the SCS/AS with a 200 OK status code and the result in the body of the HTTP response. The accumulated usage received from the PCRF shall be included if the SCS/AS requested to disable the sponsoring. If the SCEF receives a response with an error code from the PCRF, the SCEF shall not update the resource and respond to the SCS/AS with a corresponding failure code as described in subclause 5.2.6.

If the SCEF receives a traffic plane notification (e.g. the usage threshold is reached or transmission resource lost) or gets informed that the Rx session is terminated (e.g. due to the release of PDN connection), the SCEF shall send an HTTP POST message including the notified event (e.g. session terminated) and the accumulated usage to the SCS/AS identified by the notification destination URI received during session set up. The SCS/AS shall respond with an HTTP response to confirm the received notification.

In order to remove an established AS session, the SCS/AS shall send an HTTP DELETE message to the SCEF targeting the associated “Individual Chargeable Party Transaction” resource. After receiving the HTTP DELETE message, the SCEF shall remove all properties of the resource and interact with the PCRF to terminate the Rx session (as defined in 3GPP TS 29.214 [10] or 3GPP TS 29.201 [13]). After receiving the response from the PCRF, the SCEF shall send an HTTP response to the SCS/AS with a corresponding status code and the accumulated usage (if received from the PCRF).

### *** Next Change ***

4.4.13 Procedures for Setting Up an AS Session with Required QoS

This procedure is used to set up an AS session with required QoS for the service as defined in 3GPP TS 23.682 [2].

For initial AS session creation, the SCS/AS shall send an HTTP POST message to the SCEF for the “AS Session with Required QoS Subscriptions” resource. The body of HTTP POST message shall include SCS/AS Identifier, UE IP address, IP Flow description, QoS reference and notification destination address. And it may also include time period and/or traffic volume for sponsored data connectivity purpose.

After receiving the HTTP POST message, the SCEF shall authorize the request and may check if the total number of requested QoS reference has exceeded the limit for the SCS/AS. If the authorization is successful, the SCEF shall map the SCS/AS Identifier to AF Application Identifier, and if required, map the SCS/AS Identifier to ASP Identity and Sponsor Identity.
NOTE 1: Before the QoS reference is mapped to Rx parameters, the SCEF can perform a mapping from the name space of the 3rd party SCS/AS to the name space of the operator.
NOTE 2: The QoS reference referring to pre-defined QoS information in the SCEF can be mapped to media component descriptions (e.g. bandwidth, media type) according to SLA.

If the authorization performed by the SCEF is successful, then the SCEF shall act as an AF to interact with the PCRF via the Rx interface as defined in 3GPP TS 29.214 [10] or 3GPP TS 29.201 [13] and trigger a PCRF initiated IP-CAN Session Modification. The SCEF shall also request to be notified about the transmission resource status, i.e. INDICATION_OF_RELEASE_OF_BEARER, and optionally INDICATION_OF_LOSS_OF_BEARER and INDICATION_OF_RECOVERY_OF_BEARER. If the time period and/or traffic volume are received from the AF, the SCEF should subscribe to the PCRF on the USAGE REPORT event. If the “ResAllocStatus” feature is not supported, the SCEF shall subscribe to the PCRF on the INDICATION_OF_SUCCESSFUL_RESOURCES_ALLOCATION and INDICATION_OF_FAILED_RESOURCES_ALLOCATION events; otherwise only if the “resConfirmInd” is set to true, the SCEF shall subscribe to the PCRF on the INDICATION_OF_SUCCESSFUL_RESOURCES_ALLOCATION and INDICATION_OF_FAILED_RESOURCES_ALLOCATION events.

The SCEF, after receiving the AAA message over the Rx interface from the PCRF with successful result code, shall create a resource “Individual AS Session with Required QoS Subscription” which represents AS session, addressed by a URI that contains the SCS/AS identity and an SCEF-created AS session identifier, and shall respond to the SCS/AS with a 201 Created message, including the result in the body of the HTTP response and a Location header field containing the URI for the created resource. The SCS/AS shall use the URI received in the Location header in subsequent requests to the SCEF to refer to this AS session. Otherwise, the SCEF shall send an HTTP response to the SCS/AS with a corresponding status code and include the result in the body of the HTTP response. If the SCEF receives a response with an error code from the PCRF, the SCEF shall not create the resource and respond to the SCS/AS with a corresponding failure code as described in subclause 5.2.6.

In order to update the established AS session, the SCS/AS may send an HTTP PUT message to the SCEF for the “Individual AS Session with Required QoS Subscription” resource requesting to replace all properties in the existing resource, addressed by the URI received in the response to the request that has created the resource. The UE IP address shall remain unchanged from previously provided values. After receiving such message, the SCEF shall make the change and interact with the PCRF to modify the Rx session (as defined in 3GPP TS 29.214 [10] or 3GPP TS 29.201 [13]). After receiving the response with successful result code from the PCRF, the SCEF shall replace all properties of the existing resource, send an HTTP response to the SCS/AS with a corresponding status code, and include the result in the body of the HTTP response. If the SCEF receives a response with an error code from the PCRF, the SCEF shall not update the resource and respond to the SCS/AS with a corresponding failure code as described in subclause 5.2.6.

The SCS/AS may also send an HTTP PATCH message to the SCEF for the “Individual AS Session with Required QoS Subscription” resource requesting to change some created properties (e.g. Flow Description). After receiving the HTTP PATCH message, the SCEF shall make the change and interact with the PCRF to modify the Rx session (as defined in 3GPP TS 29.214 [10] or 3GPP TS 29.201 [13]). After receiving the response from the PCRF, the SCEF shall send an HTTP response to the SCS/AS with a corresponding status code and include the result in the body of the HTTP response.

If the SCEF receives a traffic plane notification (e.g. the usage threshold is reached or transmission resource lost), or if the SCEF gets informed that the Rx session is terminated (e.g. due to a release of PDN connection), the SCEF shall send an HTTP POST message including the notified event (e.g. session terminated) and the accumulated usage (if received from the PCRF) to the callback URI “notificationUri” provided by the SCS/AS during the creation of individual AS Session with Required QoS Subscription. The SCS/AS shall respond with an HTTP response to confirm the received notification.

In order to remove the established AS session, the SCS/AS shall send an HTTP DELETE message to the SCEF for the “Individual AS Session with Required QoS Subscription” resource. After receiving the HTTP DELETE message, the SCEF shall remove all properties and interact with the PCRF to terminate the Rx session (as defined in 3GPP TS 29.214 [10] or 3GPP TS 29.201 [13]). After receiving the response from the PCRF, the SCEF shall send an HTTP response to the SCS/AS with a corresponding status code and include the accumulated usage (if received from the PCRF).

### *** Next Change ***

### 5.2.1.2.5 Void

### *** Next Change ***

### 5.2.1.2.6 Void

### *** Next Change ***

### 5.2.1.3.3 Void

### *** Next Change ***

### 5.5.2.1.2 Type: ChargeableParty

This type represents the configuration of a chargeable party. The same structure is used in the configuration request and configuration response.

TABLE 5.5.2.1.2-1
Definition of type ChargeableParty

| Attribute | | | | Applicability |
|---|---|---|---|---|
| name | Data type | Cardinality | Description | (NOTE 1) |
| self | Link | 0 . . . 1 | Link to the resource | |
| | | | “Individual Chargeable Party | |
| | | | Transaction”. This parameter | |
| | | | shall be supplied by the SCEF | |
| | | | in HTTP responses. | |
| supportedFeatures | SupportedFeatures | 0 . . . 1 | Used to negotiate the | |
| | | | supported optional features of | |
| | | | the API as described in | |
| | | | subclause 5.2.7. | |
| | | | This attribute shall be | |
| | | | provided in the POST request | |
| | | | and in the response of | |
| | | | successful resource creation. | |
| notificationDestination | Link | 1 | Contains the URI to receive | |
| | | | the notification of bearer level | |
| | | | event(s) from the SCEF. | |
| requestTestNotification | boolean | 0 . . . 1 | Set to true by the SCS/AS to | Notification_ |
| | | | request the SCEF to send a | test_event |
| | | | test notification as defined in | |
| | | | subclause 5.2.5.3. Set to false | |
| | | | or omitted otherwise. | |
| websockNotifConfig | WebsockNotifConfig | 0 . . . 1 | Configuration parameters to | Notification_ |
| | | | set up notification delivery | websocket |
| | | | over Websocket protocol as | |
| | | | defined in subclause 5.2.5.4. | |
| ipv4Addr | Ipv4Addr | 0 . . . 1 | Identifies the Ipv4 address. | |
| | | | (NOTE 2) | |
| ipDomain | string | 0 . . . 1 | The IPV4 address domain | |
| | | | identifier. | |
| | | | The attribute may only be | |
| | | | provided if the ipv4Addr | |
| | | | attribute is present. | |
| ipv6Addr | Ipv6Addr | 0 . . . 1 | Identifies the Ipv6 address. | |
| | | | (NOTE 2) | |
| macAddr | MacAddr48 | 0 . . . 1 | Identifies the MAC address. | EthChgParty_ |
| | | | (NOTE 2) | 5G |
| flowInfo | array(FlowInfo) | 0 . . . N | Describes the IP flows. | |
| | | | (NOTE 2) | |
| ethFlowInfo | array | 0 . . . N | Identifies Ethernet packet | EthChgParty_ |
| | (EthFlowDescription) | | flows. | 5G |
| | | | (NOTE 2) | |
| sponsorInformation | SponsorInformation | 1 | Describes the sponsor | |
| | | | information such as who is | |
| | | | sponsoring the traffic. | |
| sponsoringEnabled | boolean | 1 | Indicates sponsoring status. | |
| referenceId | BdtReferenceId | 0 . . . 1 | The reference ID for a | |
| | | | previously selected policy of | |
| | | | background data transfer. | |
| usageThreshold | UsageThreshold | 0 . . . 1 | Time period and/or traffic | |
| | | | volume. | |
| resConfirmInd | boolean | 0 . . . 1 | Indicates whether the | ResAllocStatus |
| | | | resource allocation | |
| | | | confirmation is required. Set | |
| | | | to true when the SCS/AS | |
| | | | requires resource allocation | |
| | | | confirmation; set to false or | |
| | | | omitted otherwise. | |

NOTE 1:
Properties marked with a feature as defined in subclause 5.5.4 are applicable as described in subclause 5.2.7. If no features are indicated, the related property applies for all the features.
NOTE 2:
One of ipv4, ipv6 or MAC address shall be provided. If ipv4 or ipv6 address is provided, IP flow information shall be provided. If MAC address is provided, Ethernet flow information shall be provided.

### *** Next Change ***

### 5.5.2.1.x Type: Notification Data

This type represents the parameters which shall be notify the SCS/AS for bearer level event(s).

TABLE 5.5.2.1.x-1
Definition of the NotificationData data type

| Attribute | | | |
|---|---|---|---|
| name | Data type | Cardinality | Description |
| transaction | Link | 1 | Link to the transaction |
| | | | resource to which this |
| | | | notification is related. |
| eventReports | array | 1 . . . N | Contains the reported event |
| | (EventReport) | | and applicable information |

### *** Next Change ***

### 5.5.2.1.y Type: EventReport

This type represents an event report.

TABLE 5.5.2.1.y-1
Definition of the EventReport data type

| Attribute | | | |
|---|---|---|---|
| name | Data type | Cardinality | Description |
| event | Event | 1 | Indicates the event reported by |
| | | | the SCEF. |
| accumulated | Accumulated | 0 . . . 1 | Contains the applicable |
| Usage | Usage | | information corresponding to |
| | | | the event. |
| flowIds | array(integer) | 0 . . . N | Identifies the IP flows that |
| | | | were sent during event |
| | | | subscription |

### *** Next Change ***

### 5.5.2.x Referenced Simple Data Types and Enumerations

### 5.5.2.x.1 Introduction

This clause defines simple data types and enumerations that are referenced from data structures defined in the previous clauses. In addition, data types and enumerations defined in subclause 5.2.1 can be referenced.

### 5.5.2.x.2 Simple Data Types

The simple data types defined in table 5.5.2.x.2-1 shall be supported.

TABLE 5.5.2.x.2-1
Simple data types

| Type name | Description |
|---|---|
| [symbol] | [symbol] |

[symbol]

indicates data missing or illegible when filed

### 5.5.2.x.3 Enumeration: Event

The enumeration Event represents event reported by the SCEF.

TABLE 5.5.2.x.3-1
Enumeration Event

| | | Applicability |
|---|---|---|
| Enumeration value | Description | (NOTE) |
| SESSION_ | Indicates that Rx session | |
| TERMINATION | is terminated. | |
| LOSS_OF_BEARER | Indicates a loss of a bearer. | |
| RECOVERY_OF_ | Indicates a recovery of a | |
| BEARER | bearer. | |
| RELEASE_OF_ | Indicates a release of a | |
| BEARER | bearer. | |
| USAGE_REPORT | Indicates the usage report | |
| | event. | |
| FAILED_ | Indicates the resource | ResAllocStatus |
| RESOURCES_ | allocation is failed. | |
| ALLOCATION | | |
| SUCCESSFUL_ | Indicates the resource | ResAllocStatus |
| RESOURCES_ | allocation is successful. | |
| ALLOCATION | | |

NOTE:
Properties marked with a feature as defined in subclause 5.5.4 are applicable as described in subclause 5.2.7. If no features are indicated, the related property applies for all the features.

### *** Next Change ***

### 5.5.4 Used Features

The table below defines the features applicable to the ChargeableParty API. Those features are negotiated as described in subclause 5.2.7.

TABLE 5.5.4-1
Features used by ChargeableParty API

| Feature | | |
|---|---|---|
| Number | Feature | Description |
| 1 | Notification_ | The delivery of notifications over Websocket is supported |
| | websocket | according to subclause 5.2.5.4. This feature requires that |
| | | the Notification_test_event feature is also supported. |
| 2 | Notification_test_ | The testing of notification connection is supported |
| | event | according to subclause 5.2.5.3. |
| 3 | EthChgParty_5G | Chargeable Party for Ethernet UE. This feature may only |
| | | be supported in 5G. |
| 4 | MacAddressRange_ | Indicates the support of a set of MAC addresses with a |
| | 5G | specific range in the traffic filter. This feature may only be |
| | | supported in 5G. |
| X | ResAllocStatus | Indicates the support of resource allocation status. |

Feature: A short name that can be used to refer to the bit and to the feature, e.g. “Notification”.
Description: A clear textual description of the feature.

### *** Next Change ***

### 5.14.2.1.2 Type: AsSessionWithQoSSubscription

This type represents an AS session request with specific QoS for the service provided by the SCS/AS to the SCEF via T8 interface. The structure is used for subscription request and response.

TABLE 5.14.2.1.2-1
Definition of type AsSessionWithQoSSubscription

| Attribute | | | | Applicability |
|---|---|---|---|---|
| name | Data type | Cardinality | Description | (NOTE 1) |
| self | Link | 0 . . . 1 | Link to the resource “Individual | |
| | | | AS Session with Required QoS | |
| | | | Subscription”. | |
| | | | This parameter shall be supplied | |
| | | | by the SCEF in HTTP responses. | |
| supportedFeatures | SupportedFeatures | 0 . . . 1 | Used to negotiate the supported | |
| | | | optional features of the API as | |
| | | | described in subclause 5.2.7. | |
| | | | This attribute shall be provided | |
| | | | in the POST request and in the | |
| | | | response of successful resource | |
| | | | creation. | |
| notificationDestination | Link | 1 | Contains the URL to receive the | |
| | | | notification bearer level event(s) | |
| | | | from the SCEF. | |
| flowInfo | array(FlowInfo) | 0 . . . N | Describe the IP data flow which | |
| | | | requires QoS. | |
| | | | (NOTE 2) | |
| ethFlowInfo | array | 0 . . . N | Identifies Ethernet packet flows. | EthAsSessionQoS_ |
| | (EthFlowDescription) | | (NOTE 2) | 5G |
| qosReference | string | 0 . . . 1 | Identifies a pre-defined QoS | |
| | | | information | |
| altQoSReferences | array(string) | 0 . . . N | Identifies an ordered list of pre- | AlternativeQoS_ |
| | | | defined QoS information. The | 5G |
| | | | lower the index of the array for a | |
| | | | given entry, the higher the | |
| | | | priority. | |
| ueIpv4Addr | Ipv4Addr | 0 . . . 1 | The Ipv4 address of the UE. | |
| | | | (NOTE 2) | |
| ipDomain | string | 0 . . . 1 | The IPV4 address domain | |
| | | | identifier. | |
| | | | The attribute may only be | |
| | | | provided if the ueIpv4Addr | |
| | | | attribute is present. | |
| ueIpv6Addr | Ipv6Addr | 0 . . . 1 | The Ipv6 address of the UE. | |
| | | | (NOTE 2) | |
| macAddr | MacAddr48 | 0 . . . 1 | Identifies the MAC address. | EthAsSessionQoS_ |
| | | | (NOTE 2) | 5G |
| usageThreshold | UsageThreshold | 0 . . . 1 | Time period and/or traffic | |
| | | | volume in which the QoS is to be | |
| | | | applied. | |
| sponsorInfo | SponsorInformation | 0 . . . 1 | Indicates a sponsor information | |
| qosMonInfo | QosMonitoring | 0 . . . 1 | Qos Monitoring information. It | QoSMonitoring_ |
| | Information | | can be present when the event | 5G |
| | | | “QOS_MONITORING” is | |
| | | | subscribed. | |
| requestTestNotification | boolean | 0 . . . 1 | Set to true by the SCS/AS to | Notification_ |
| | | | request the SCEF to send a test | test_event |
| | | | notification as defined in | |
| | | | subclause 5.2.5.3. Set to false or | |
| | | | omitted otherwise. | |
| websockNotif | WebsockNotifConfig | 0 . . . 1 | Configuration parameters to set | Notification_ |
| Config | | | up notification delivery over | websocket |
| | | | Websocket protocol as defined in | |
| | | | subclause 5.2.5.4. | |
| resConfirmInd | boolean | 0 . . . 1 | Indicates whether the resource | ResAllocStatus |
| | | | allocation confirmation is | |
| | | | required. Set to true when the | |
| | | | SCS/AS requires resource | |
| | | | allocation confirmation; set to | |
| | | | false or omitted otherwise. | |

NOTE 1:
Properties marked with a feature as defined in subclause 5.14.4 are applicable as described in subclause 5.2.7. If no features are indicated, the related property applies for all the features.
NOTE 2:
One of “ueIpv4Addr”, “ueIpv6Addr” or “macAddr” shall be included. If ipv4 or ipv6 address is provided, IP flow information shall be provided. If MAC address is provided, Ethernet flow information shall be provided.

### *** Next Change ***

### 5.14.2.2.3 Enumeration: UserPlaneEvent

The enumeration UserPlaneEvent represents the user plane event.

TABLE 5.14.2.2.3-1
Enumeration UserPlaneEvent

| | | Applicability |
|---|---|---|
| Enumeration value | Description | (NOTE) |
| SESSION_TERMINATION | Indicates that Rx | |
| | session is terminated. | |
| LOSS_OF_BEARER | Indicates a loss of a | |
| | bearer. | |
| RECOVERY_OF_BEARER | Indicates a recovery of | |
| | a bearer. | |
| RELEASE_OF_BEARER | Indicates a release of | |
| | a bearer. | |
| USAGE_REPORT | Indicates the usage | |
| | report event. | |
| FAILED_RESOURCES_ALLOCATION | Indicates the resource | ResAllocStatus |
| | allocation is failed. | |
| SUCCESSFUL_RESOURCES_ALLOCATION | Indicates the resource | ResAllocStatus |
| | allocation is successful. | |
| QOS_GUARANTEED | The QoS targets of | AlternativeQoS_5G |
| | one or more SDFs are | |
| | guaranteed again. | |
| QOS_NOT_GUARANTEED | The QoS targets of | AlternativeQoS_5G |
| | one or more SDFs are | |
| | not being guaranteed. | |
| QOS_MONITORING | Indicates a QoS | QoSMonitoring_5G |
| | monitoring event. | |

NOTE:
Properties marked with a feature as defined in subclause 5.14.4 are applicable as described in subclause 5.2.7. If no features are indicated, the related property applies for all the features.

### *** Next Change ***

### 5.14.4 Used Features

The table below defines the features applicable to the AsSessionWithQoS API. Those features are negotiated as described in subclause 5.2.7.

TABLE 5.14.4-1
Features used by AsSessionWithQoS API

| Feature | | |
|---|---|---|
| Number | Feature | Description |
| 1 | Notification_ | The delivery of notifications over |
| | websocket | Websocket is supported according to |
| | | subclause 5.2.5.4. This feature requires |
| | | that the Notification_test_event |
| | | featute is also supported. |
| 2 | Notification_ | The testing of notifications connections is |
| | test_event | supported according to subclause 5.2.5.3. |
| 3 | EthAsSessionQoS_ | Setting up required QoS for Ethernet UE. |
| | 5G | This feature may only be supported in 5G. |
| 4 | MacAddressRange_ | Indicates the support of a set of MAC |
| | 5G | addresses with a specific range in the |
| | | traffic filter. This feature may only be |
| | | supported in 5G. |
| 5 | AlternativeQoS_ | Indicates the support of alternative QoS |
| | 5G | requirements and the QoS notification (i.e. |
| | | whether the QoS targets for SDF(s) are not |
| | | guaranteed or guaranteed again). This |
| | | feature may only be supported in 5G. |
| 6 | QoSMonitoring_ | Indicates the support of QoS Monitoring. |
| | 5G | This feature may only be supported in 5G. |
| X | ResAllocStatus | Indicates the support of resource allocation |
| | | status. |

Feature: A short name that can be used to refer to the bit and to the feature, e.g. “Notification”.
Description: A clear textual description of the feature.

### *** End of Changes ***

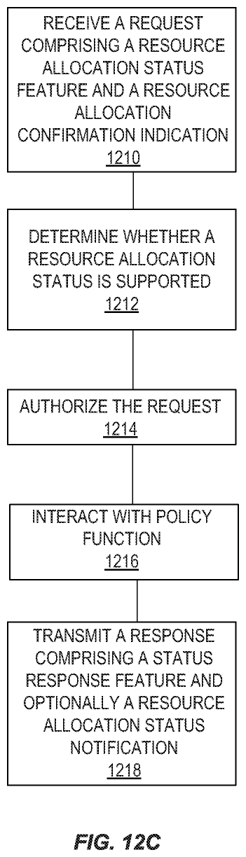

FIG. 13 is a schematic block diagram of a network node 1300 according to some embodiments of the present disclosure. Optional elements are represented by dashed boxes. The network node 1300 may be, for example, a network node that implements the ARF 1200 or the EF 1202 having the functionality described herein. As illustrated, the network node 1300 includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. The one or more processors 1304 operate to provide one or more functions of a network node 1300 as described herein (e.g. one or more functions of the ARF 1200 or the EF 1202 with respect to FIG. 12A, FIG. 12B, and/or FIG. 12C). In some embodiments, the function(s) are implemented in software that is stored, e.g., in the memory 1306 and executed by the one or more processors 1304.

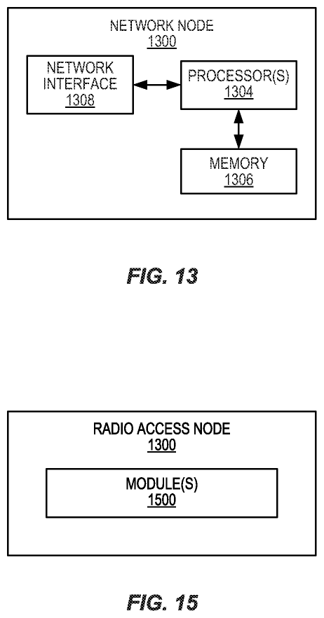

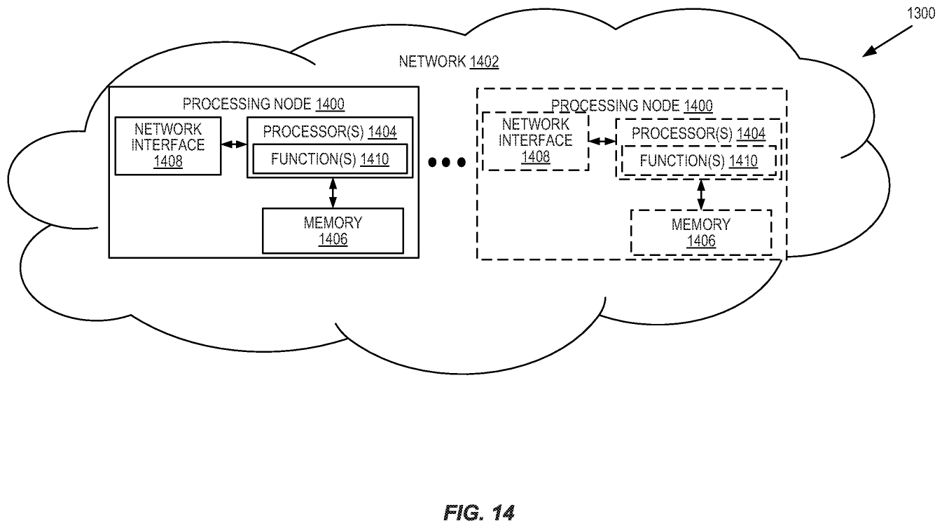

FIG. 14 is a schematic block diagram that illustrates a virtualized embodiment of the network node 1300 according to some embodiments of the present disclosure. As used herein, a “virtualized” network node is an implementation of the network node 1300 in which at least a portion of the functionality of the network node 1300 is implemented as a virtual component(s) (e.g., via a virtual machine(s) executing on a physical processing node(s) in a network(s)). As illustrated, in this example, the network node 1300 may include one or more processing nodes 1400 coupled to or included as part of a network(s) 1402. Each processing node 1400 includes one or more processors 1404 (e.g., CPUs, ASICs, FPGAs, and/or the like), memory 1406, and a network interface 1408.

In this example, functions 1410 of the network node 1300 described herein (e.g. one or more functions of the ARF 1200 or the EF 1202) are implemented at the one or more processing nodes 1400 in any desired manner. In some particular embodiments, some or all of the functions 1410 of the network node 1300 described herein are implemented as virtual components executed by one or more virtual machines implemented in a virtual environment(s) hosted by the processing node(s) 1400.

In some embodiments, a computer program including instructions which, when executed by at least one processor, causes the at least one processor to carry out the functionality of network node 1300 or a node (e.g., a processing node 1400) implementing one or more of the functions 1410 of the network node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the network node 1300 according to some other embodiments of the present disclosure. The network node 1300 includes one or more modules 1500, each of which is implemented in software. The module(s) 1500 provide the functionality of the network node 1300 described herein (e.g. one or more functions of the ARF 1200 or the EF 1202). This discussion is equally applicable to the processing node 1400 of FIG. 14 where the modules 1500 may be implemented at one of the processing nodes 1400 or distributed across multiple processing nodes 1400.

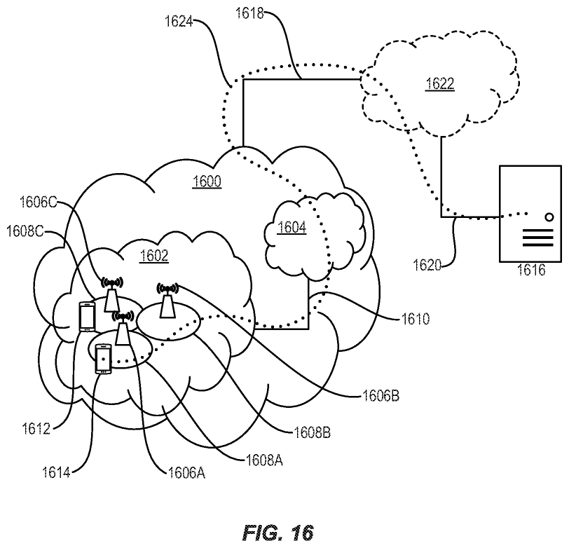

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

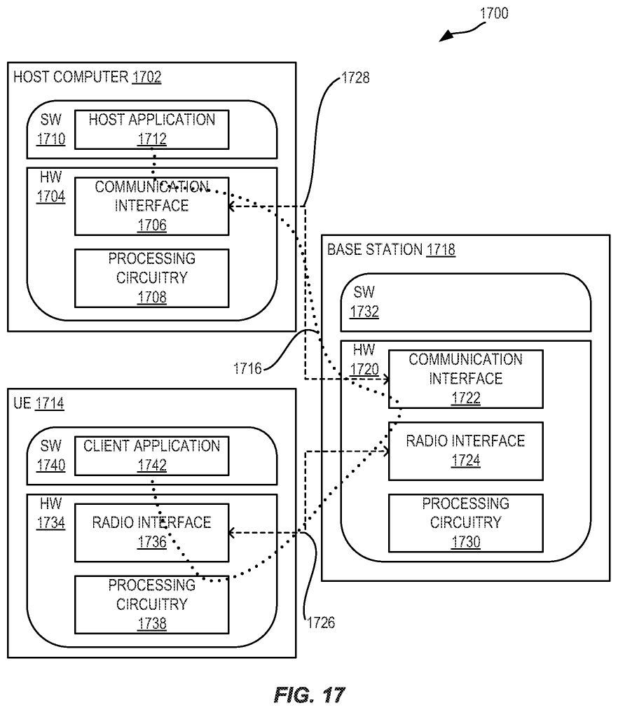

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer's 1702 measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

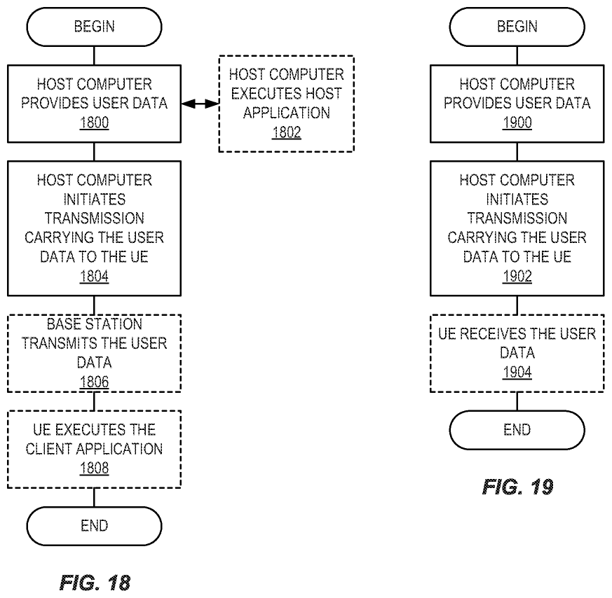

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002 (which may be optional), the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

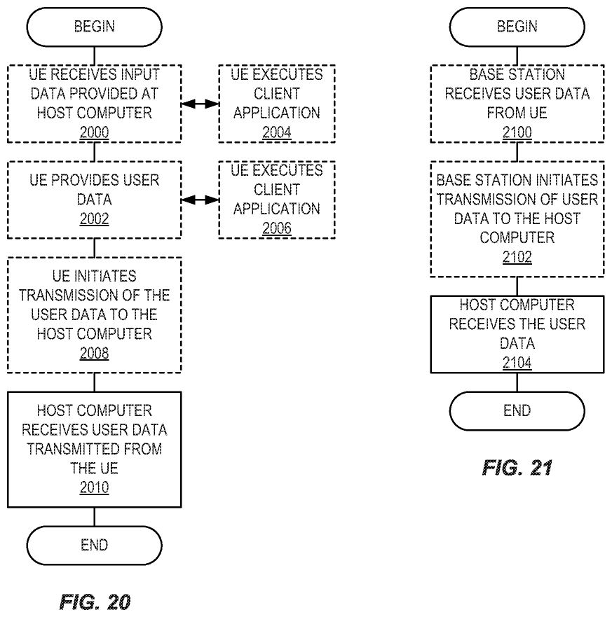

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104, the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ARF Application Related Function
AS Application Server
ASIC Application Specific Integrated Circuit
AUSF Authentication Server Function
CPU Central Processing Unit
DN Data Network
DSP Digital Signal Processor
eNB Enhanced or Evolved Node B
EF Exposure Function
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PF Policy Function
PCRF Policy And Charging Rules Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SCS Service Capability Server
SMF Session Management Function
TCI Transmission Configuration Indicator
TRP Transmission/Reception Point
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method of operation of an application related function (ARF), the method comprising:
transmitting, to an exposure function (EF), a request comprising a resource allocation confirmation indication that indicates whether a resource allocation status notification is required, wherein the resource allocation status notification indicates resource allocation success or resource allocation failure.

2. The method of claim 1 wherein the request further comprises a resource allocation status feature that indicates whether the ARF supports a resource allocation status.

3. The method of claim 2 further comprising receiving, from the EF, a response comprising a status response feature that indicates whether both the ARF and the EF support the resource allocation status.

4. The method of claim 3 wherein when the resource allocation confirmation indication indicates that the resource allocation status notification is required by the ARF and the status response feature indicates that both the ARF and the EF support the resource allocation status, the response further comprises a resource allocation status notification.

5. The method of claim 3 wherein when the resource allocation confirmation indication indicates that the resource allocation status notification is not required by the ARF, the status response feature indicates that at least one of the ARF and the EF does not support the resource allocation status, or when the resource allocation confirmation indication indicates that the resource allocation status notification is not required by the ARF and the status response feature indicates that at least one of the ARF and the EF does not support the resource allocation status, the method further comprises refraining from waiting for a resource allocation status notification from the EF.

6. The method of claim 5 wherein when the resource allocation confirmation indication indicates that the resource allocation status notification is not required by the ARF, the method further comprises refraining from waiting for a resource allocation status notification from the EF.

7. The method of claim 5 wherein when the status response feature indicates that at least one of the ARF and the EF does not support the resource allocation status, the method further comprises refraining from waiting for a resource allocation status notification from the EF.

8. The method of claim 3, wherein:
the request is:
a request to set up an application server (AS) session or an application function (AF) session with required quality of service (QoS);
a request to update the AS session or the AF session with required QoS;
a request to set a chargeable party at an AS session set-up or an AF session set-up; or
a request to change the chargeable party during the AS session or the AF session; and
the response is:
a response to set up an AS session or an AF session with required QoS;
a response to update the AS session or the AF session with required QoS;
a response to set a chargeable party at an AS set-up or an AF session set-up; or
a response to change the chargeable party during the AS session or the AF session, respectively.

9. The method of claim 3, wherein:
a bitmask is used for the resource allocation confirmation indication to indicate whether a resource allocation status notification is required;
a bitmask is used for the resource allocation status feature to indicate whether the ARF supports the resource allocation status; or
a bitmask is used for the status response feature to indicate whether both the ARF and the EF support the resource allocation status.

10. The method of claim 3, wherein:
the ARF is in a Fifth Generation system;
the ARF is an application function (AF); and
the EF is a network exposure function (NEF).

11. The method of claim 10, wherein:
the request is:
a request to set up an application function (AF) session with required quality of service (QoS);
a request to update the AF session with required QoS;
a request to set a chargeable party at an AF session set-up; or
a request to change the chargeable party during the AF session; and
the response is:
a response to set up an AF session with required QoS;
a response to update the AF session with required QoS;
a response to set a chargeable party at an AF session set-up; or
a response to change the chargeable party during the AF session, respectively.

12. The method of claim 3, wherein:
the ARF is in a Fourth Generation system;
the ARF is a services capability server or an application server (SCS/AS; and
the EF is a service capability exposure function (SCEF).

13. The method of claim 12, wherein:
the request is:
a request to set up an application server (AS) session with required quality of service (QoS);
a request to update the AS session with required QoS;
a request to set a chargeable party at an AS session set-up; or
a request to change the chargeable party during the AS session; and
the response is:
a response to set up an AS session with required QoS;
a response to update the AS session with required QoS;
a response to set a chargeable party at an AS session set-up; or
a response to change the chargeable party during the AS session, respectively.

14. (canceled)

15. A network node that implements an application related function (ARF), the network node comprising:
a network interface;
processing circuitry associated with the network interface; and
a memory comprising instructions which, when executed by the processing circuitry, cause the network node to:
transmit, to an exposure function (EF), a request comprising a resource allocation confirmation indication that indicates whether a resource allocation status notification is required, wherein the resource allocation status notification indicates resource allocation success or resource allocation failure.

16. The network node of claim 15 wherein the request further comprises a resource allocation status feature that indicates whether the ARF supports a resource allocation status.

17. The network node of claim 16 wherein the network node to further receive, from the EF, a response comprising a status response feature that indicates whether both the ARF and the EF support the resource allocation status.

18. A method of operation of an exposure function (EF), the method comprising:
receiving (1210), from an application related function (ARF), a request comprising a resource allocation confirmation indication that indicates whether a resource allocation status notification is required, wherein the resource allocation status notification indicates resource allocation success or resource allocation failure.

19-37. (canceled)

38. A network node that implements an exposure function (EF), the network node comprising:
a network interface;
processing circuitry associated with the network interface; and
a memory comprising instructions which, when executed by the processing circuitry, cause the network node to:
receive, from an application related function (ARF), a request comprising a resource allocation confirmation indication that indicates whether a resource allocation status notification is required, wherein the resource allocation status notification indicates resource allocation success or resource allocation failure.

39-51. (canceled)
